(19) United States
(12) Patent Application Publication
(10) Pub. No.: US 2016/0175769 A1
(43) Pub. Date: Jun. 23, 2016

(54) GAS SCAVENGERS

(71) Applicant: Hexion Inc., Columbus, OH (US)

(72) Inventors: Cyrille KAMOUN, Fulshear, TX (US); Jan BEETGE, Pearland, TX (US)

(21) Appl. No.: 14/968,488

(22) Filed: Dec. 14, 2015

Related U.S. Application Data
(60) Provisional application No. 62/093,924, filed on Dec. 18, 2014.
(60) Provisional application No. 62/235,158, filed on Sep. 30, 2015.

(51) Int. Cl. B01D 53/52; B01J 20/22

(52) U.S. Cl. CPC B01D 53/52; B01J 20/22; B01D 2251/80

(57) ABSTRACT

The implementations described herein generally relate to methods and chemical compositions for scavenging sulfur-containing compounds, and more particularly to methods and compositions for scavenging, for example, H₂S and mercaptans from gaseous sulfur-containing streams. In one implementation, a method for scavenging a sulfur-containing compound from a gaseous sulfur-containing stream is provided. The method comprises contacting the gaseous sulfur-containing stream with an effective amount of a multi-component scavenging system for scavenging the sulfur-containing compound. The multi-component scavenging system comprises at least one scavenger for scavenging the sulfur-containing compound and at least one hygroscopic agent. The gaseous sulfur-containing stream has an amount of water less than or equal to 100% relative humidity and the gaseous sulfur-containing stream comprises the sulfur-containing compound.

### RELATED APPLICATION DATA

This application claims benefit to U.S. Provisional Application No. 62/093,924, filed Dec. 18, 2014 and further to U.S. Provisional Application No. 62/235,158, filed Sep. 30, 2015 of which the entire contents of both applications are incorporated by reference herein.

### FIELD

The implementations described herein generally relate to methods and chemical compositions for scavenging sulfur-containing compounds, and more particularly to methods and compositions for scavenging, for example, sulfur-containing compounds such as H₂S and mercaptans from gaseous sulfur-containing streams.

### BACKGROUND

In the drilling, completions, production, transport, storage, and processing of crude oil and natural gas, including waste water associated with crude oil and gas production, and in the storage of residual fuel oil, contaminants are often encountered. These contaminants may include, but are not necessarily limited to, sulfur-containing compounds such as hydrogen sulfide (H₂S), mercaptans, and organic sulfides. The presence of H₂S and mercaptans is extremely objectionable because they are an acute health hazard and often highly corrosive. The Environmental Protection Agency and other regulatory agencies worldwide strictly control the release of H₂S into the environment. The H₂S concentration in these reserves prior to treatment typically varies with location and is usually higher in natural gas than in crude oil reserves. In natural gas reserves, for example, H₂S may vary from less than 100 parts per million (“ppm”) to 3,000 ppm. Permitted H₂S levels will also vary by location. The United States limits H₂S in natural gas pipelines to 4 ppm or 0.3 grams per 100 standard cubic feet (0.3 gr/100 scf).

Generally, hydrocarbon streams are treated to remove H₂S, mercaptans, or organic sulfides by using chemicals that will react with sulfide contaminants. These chemicals are called scavengers, or sweetening agents. Many of the currently available scavenging systems have limitations, particularly in dry gas environments, including, but not necessarily limited to, low reactivity and therefore low efficiency, containing atypical components or elements that may adversely affect fuel or fluid quality, or may present toxicity concerns themselves.

It would be desirable if methods and compositions could be devised that would remove, reduce, eliminate, take out or otherwise remove such contaminants from dry gas streams or non-dry gas streams, as well as reduce, alleviate or eliminate corrosion caused by these undesired contaminants.

### SUMMARY

The implementations described herein generally relate to methods and chemical compositions for scavenging sulfur-containing compounds, and more particularly to methods and compositions for scavenging, for example, sulfur-containing compounds such as H₂S and mercaptans from gaseous sulfur-containing streams. In one implementation, a method for scavenging a sulfur-containing compound from a gaseous sulfur-containing stream is provided. The method comprises contacting the gaseous sulfur-containing stream with a multi-component scavenging system for scavenging the sulfur-containing compound. The multi-component scavenging system comprises at least one scavenger for scavenging the sulfur-containing compound and at least one hygroscopic agent. The gaseous sulfur-containing stream has an amount of water less than or equal to 100% relative humidity and the gaseous sulfur-containing stream comprises the sulfur-containing compound.

In another implementation, a multi-component scavenging system for scavenging a sulfur-containing compound is provided. The multi-component scavenging system comprises at least one scavenger for scavenging the sulfur-containing compound and at least on hygroscopic agent selected from the group consisting of: at least one alcohol of C₁-C₈, at least one poly(ol) of C₁-C₈, at least one amine of C₁-C₈, at least one poly(amine) of C₁-C₈, at least one C₁-C₄ poly(amine) comprising two —NH₂ groups functional groups, at least one poly(ether), at least one aldehyde of C₁-C₈, at least one hygroscopic salt, and mixtures thereof.

In yet another implementation, a treated stream is provided. The treated stream comprises a gaseous sulfur-containing stream, a sulfur-containing contaminant, and a multi-component scavenging system in an amount effective to at least partially remove the sulfur-containing contaminant from the gaseous sulfur-containing stream. The multi-component scavenging system comprises at least one scavenger for scavenging the sulfur-containing compound and at least on hygroscopic agent selected from the group consisting of: at least one alcohol of C₁-C₈, at least one poly(ol) of C₁-C₈, at least one amine of C₁-C₈, at least one poly(amine) of C₁-C₈, at least one C₁-C₄ poly(amine) comprising two —NH₂ groups functional groups, at least one poly(ether), at least one aldehyde of C₁-C₈, at least one hygroscopic salt, and mixtures thereof.

The features, functions, and advantages that have been discussed can be achieved independently in various implementations or may be combined in yet other implementations, further details of which can be seen with reference to the following description and drawings.

### BRIEF DESCRIPTION OF ILLUSTRATIONS

So that the manner in which the above-recited features of the present disclosure can be understood in detail, a more particular description of the disclosure briefly summarized above may be had by reference to implementations, some of which are illustrated in the appended drawings. It is to be noted, however, that the appended drawings illustrate only typical implementations of this disclosure and are therefore not to be considered limiting of its scope, for the disclosure may admit to other equally effective implementations.

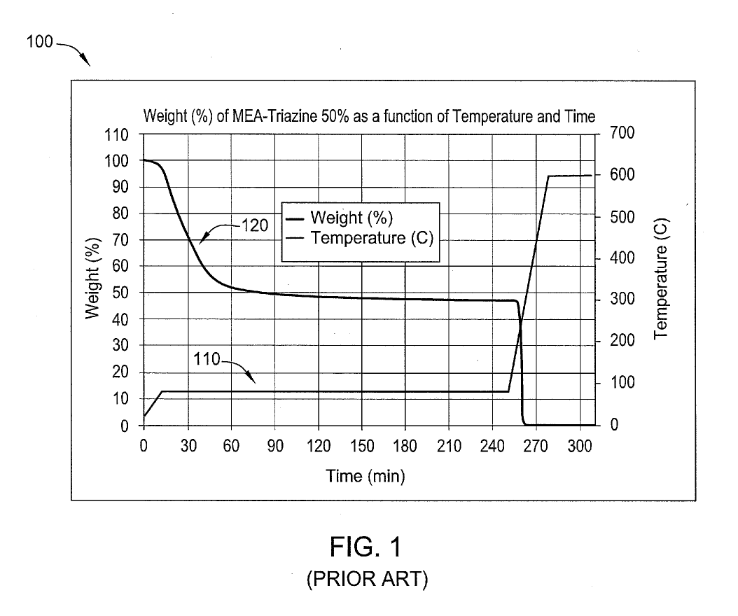

FIG. 1 is a graph illustrating the change in weight percent of a known monoethanolamine-triazine (“MEA-Triazine”) composition as a function of temperature and time;

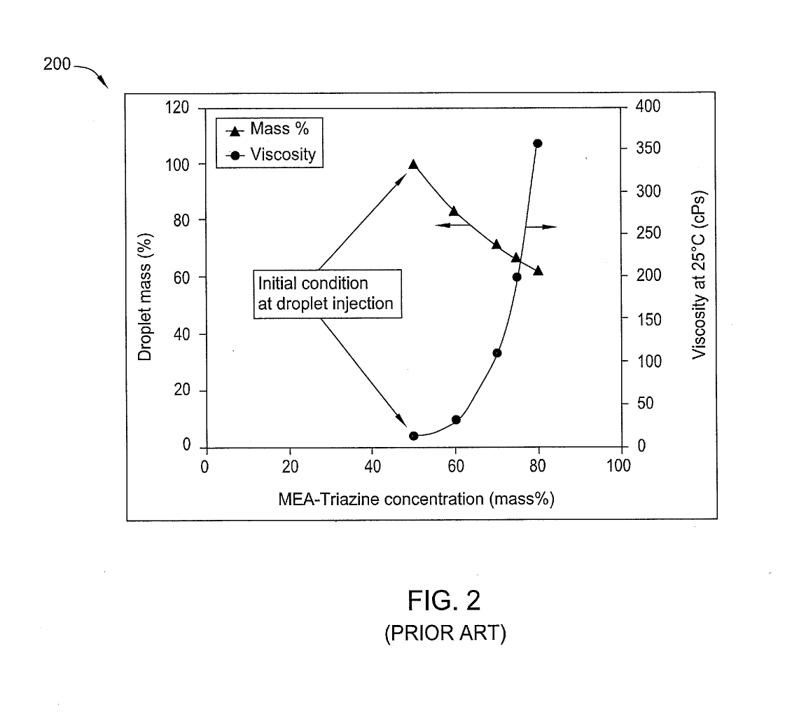

FIG. 2 is a graph illustrating the effect of mass loss of a droplet due to water evaporation on viscosity of droplet of a known MEA-Triazine composition;

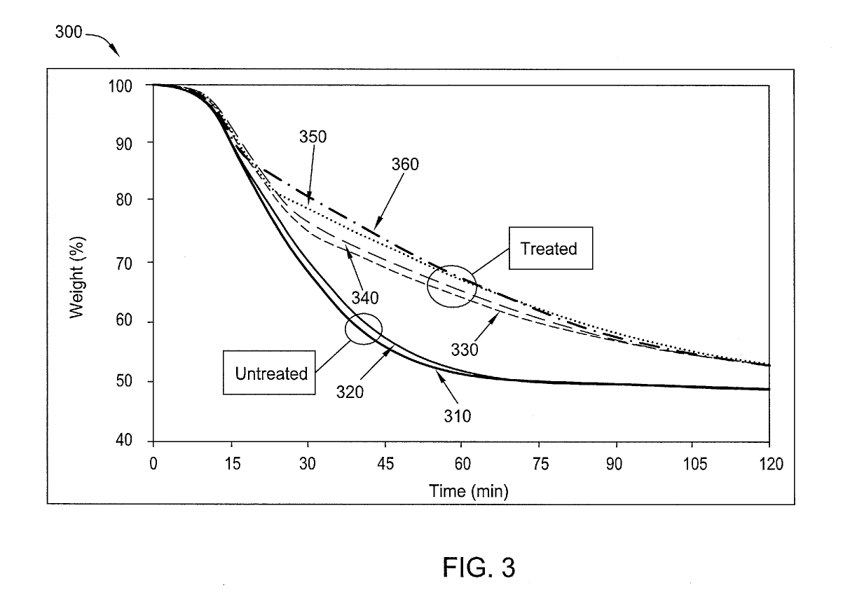

FIG. 3 is a graph illustrating the change in weight percent of a triazine scavenger treated with glycerol according to implementations described herein versus an untreated scavenger as a function of temperature and time; and

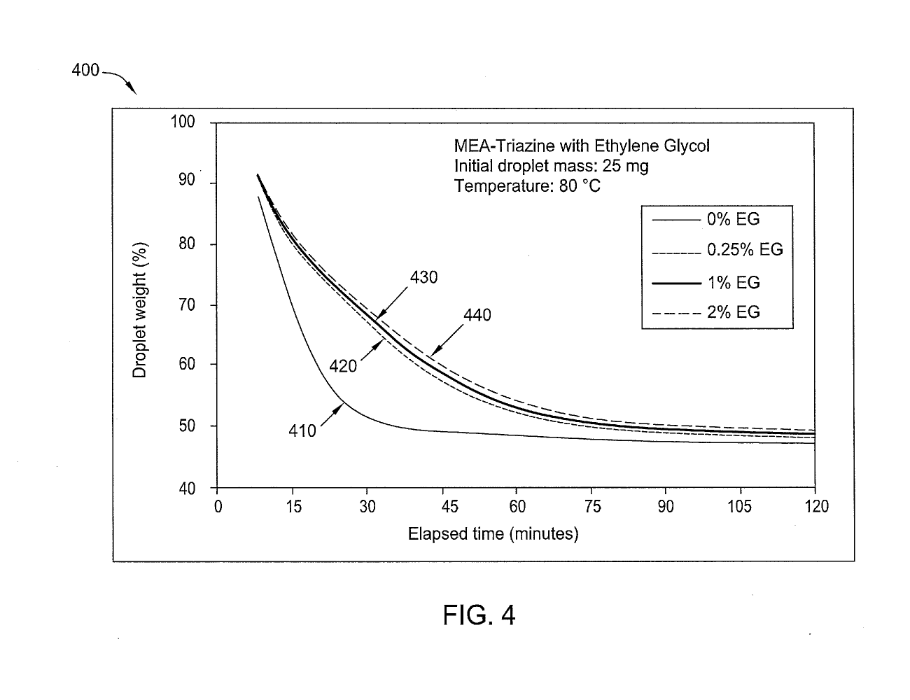

FIG. 4 is a graph illustrating the change in weight percent of a triazine scavenger treated with ethylene glycol according to implementations described herein versus an untreated scavenger as a function of time.

To facilitate understanding, identical reference numerals have been used, wherever possible, to designate identical elements that are common to the Figures. Additionally, elements of one implementation may be advantageously adapted for utilization in other implementations described herein.

### DETAILED DESCRIPTION

The following disclosure describes processes and compositions for the removal of sulfur-containing compounds from gaseous sulfur-containing streams, such as gaseous sulfur-containing hydrocarbon streams, and devices for carrying out the aforementioned process. Certain details are set forth in the following description and in FIGS. 1-4 to provide a thorough understanding of various implementations of the disclosure. Other details describing well-known methods and systems often associated with the removal of sulfur-containing compounds are not set forth in the following disclosure to avoid unnecessarily obscuring the description of the various implementations.

Many of the details, components and other features described herein are merely illustrative of particular implementations. Accordingly, other implementations can have other details, components, and features without departing from the spirit or scope of the present disclosure. In addition, further implementations of the disclosure can be practiced without several of the details described below.

As used herein, the following terms have the meaning set forth below unless otherwise stated or clear from the context of their use.

When introducing elements of the present disclosure or exemplary aspects or implementation(s) thereof, the articles “a,” “an,” “the” and “said” are intended to mean that there are one or more of the elements.

The terms “comprising,” “including” and “having” are intended to be inclusive and mean that there may be additional elements other than the listed elements.

The term “dry” gas stream refers to a gas stream having less than or equal to 10 parts-per-million by volume (“ppmV”) moisture.

The term “hygroscopic” denotes hydrophilic active agents comprising at least one function that is capable of forming hydrogen bonds with water. In particular, O—H and N—H bonds are essentially concerned. Under favorable orientation conditions, hydrogen bonds may form between these molecules. In other words, the hydrogen bonds (or H bonds) may appear once a polar hydrogen is close to an atom bearing lone pairs (mainly oxygen and nitrogen in biomolecules). The formation of hydrogen bonds is a manner for the water molecules of “attaching themselves” to solute molecules.

The term “relative humidity” refers to the amount of water vapor present in the air, expressed as a percentage of the maximum that the air could hold at the given temperature; the ratio of the actual water vapor pressure to the saturation vapor pressure.

The term “scavenger” encompasses a combination of components or additives, whether added to a stream separately or together, that scavenge one or more of the contaminants noted herein.

The term “triazine” refers to a compound which contains three carbon atoms and three nitrogen atoms in a six-membered ring and can be either carbon- or nitrogen-substituted.

All percentages, preferred amounts or measurements, ranges and endpoints thereof herein are inclusive, that is, “less than about 10” includes about 10. “At least” is, thus, equivalent to “greater than or equal to,” and “at most” is, thus, equivalent “to less than or equal to.” Numbers herein have no more precision than stated. Thus, “105” includes at least from 104.5 to 105.49. Furthermore, all lists are inclusive of combinations of two or more members of the list. All ranges from a parameter described as “at least,” “greater than,” “greater than or equal to” or similarly, to a parameter described as “at most,” “up to,” “less than,” “less than or equal to” or similarly are preferred ranges regardless of the relative degree of preference indicated for each parameter. Thus a range that has an advantageous lower limit combined with a most preferred upper limit is preferred for the practice of the implementations described herein. All amounts, ratios, proportions and other measurements are by weight unless stated otherwise. All percentages refer to weight percent (wt. %) based on total composition according to the practice of the invention unless stated otherwise.

Triazine solutions are very efficient sulfur-containing compound scavengers when atomized in gas of high moisture content and are widely used for this purpose. The most widely used triazine solutions are monoethanolamine-triazine (“MEA-Triazine”) and monomethylamine-triazine (“MMA-Triazine”). Nevertheless, their efficiency is insufficient when they are atomized in dry gas.

It has been discovered that the addition of a small percentage of a hygroscopic agent to the sulfur-containing compound scavengers, reduces the evaporation rate of water found in the sulfur-containing compound scavenger. Sulfur-containing compound scavengers are typically sprayed in small droplets, for example, 5 to 50 micrometers, in hot dry gas. Since the droplets are small, their surface to volume ratio is high, which leads to a high evaporation rate, a fast increase of their viscosity, and a corresponding drop of the diffusion rate of H₂S through the surface layer of the droplet into the core of the droplets. Thus the triazine contained in the core of the droplets does not have time to fully react with H₂S, which results in a waste of the triazine during the process. Not to be bound by theory but it is believed that decreasing the evaporation rate delays the increase of the viscosity of the surface layer of the triazine droplets and provides additional time for the triazine contained in the core of the droplet to react with H₂S.

It has also been discovered that the evaporation rate of the fluid in a droplet will slow down with increasing humidity in the droplet's immediate environment to reduce the effect or contribution of the hygroscopic agent, but where humidity levels approach saturation, a suitable hygroscopic agent may absorb some of the surrounding moisture to reduce the initial bulk viscosity of the droplet fluid to increase the diffusion rate of H₂S into the core of the droplet to increase scavenger efficiency compared to a scavenger product that does not contain a hygroscopic component. The hygroscopic agent thus will reduce evaporation rate in low humidity conditions or absorb moisture in very high humidity situations, reducing viscosity of the droplet fluid in both extreme cases to increase diffusion rate of H₂S into the droplet core to increase efficiency of the scavenger, compared to a scavenger product that does not contain a hygroscopic agent.

In some implementations, the sulfur-containing stream to be treated is a gaseous sulfur-containing hydrocarbon stream, especially a natural gas stream, an associated gas stream, or a refinery gas stream. Natural gas is a general term that is applied to mixtures of inert and light hydrocarbon components that are derived from natural gas wells. The main component of natural gas is methane. Further, often ethane, propane and butane are present. In some cases (small) amounts of higher hydrocarbons may be present, often indicated as natural gas liquids or condensates. Inert compounds may be present, especially nitrogen, carbon dioxide and, occasionally, helium. When produced together with oil, the natural gas is usually indicated as associated gas.

Sulfur-containing compounds, for example, hydrogen sulfide, mercaptans, sulfides, disulfides, thiophenes and aromatic mercaptans may be present in natural gas in varying amounts. Refinery streams concern crude oil derived gaseous sulfur-containing streams containing smaller or larger amounts of sulfur compounds. Also recycle streams and bleed streams of hydrotreatment processes, especially hydrodesulfurization processes, may be treated by the process according to the present disclosure.

The sulfur-containing compounds which may be removed by the processes of the present disclosure are in principle all compounds which are removed by scavengers. Usually the sulfur-containing compounds include, for example, hydrogen sulfide, carbonyl sulfide, mercaptans, organic sulfides, organic disulfides, thiophene compounds, aromatic mercaptans, or mixtures thereof. Suitable mercaptans include C₁-C₆ mercaptans, such as C₁-C₄ mercaptans. Suitable organic sulfides include di-C₁-C₄-alkyl sulfides. Suitable organic disulfides include di-C₁-C₄-alkyl disulfides. Suitable aromatic mercaptans include phenyl mercaptan.

In some implementations, the gaseous sulfur-containing stream can be a dry gaseous sulfur-containing stream. The dry gaseous sulfur-containing stream may have an amount of water less than or equal to 10 ppmV; an amount of water less than or equal to 5 ppmV; an amount of water less than or equal to 1 ppmV. The dry gaseous sulfur-containing stream may have an amount of water between 0.01 ppmV and 10 ppmV; an amount of water between 1 ppmV and 10 ppmV; an amount of water between 1 ppmV and 5 ppmV; an amount of water between 5 ppmV and 10 ppmV.

In some implementations, the gaseous sulfur-containing stream, may contain a certain amount of water, preferably up to 50% mol and more preferably less than or equal to 10,000 ppm mol.

In some implementations, the gaseous sulfur-containing stream is a gas stream having a certain relative water humidity. The gaseous sulfur-containing stream may have a relative humidity of less than or equal to 100%, such as from 1 to 100%; a relative humidity of less than or equal to 60%; a relative humidity of less than or equal to 40%; a relative humidity of less than or equal to 20%; a relative humidity of less than or equal to 10%; a relative humidity of less than or equal to 5%. In some implementations, the gaseous sulfur-containing stream is a gas stream having a relative humidity between 1 and 99%; a relative humidity between 1% and 5%; a relative humidity between 5% and 10%; a relative humidity between 1% and 20%; a relative humidity between 20% and 40%; a relative humidity between 40% and 60%; a relative humidity between 60% and 80%; a relative humidity between 60% and 99%. In some implementations, the gaseous sulfur-containing stream may be super saturated to contain mist or droplets of condensed water in a 100% humidity matrix.

In some implementations, the aforementioned relative humidity values are in combination with a temperature of −10 degrees Celsius or greater; room temperature or greater; between −10 degrees Celsius and 150 degrees Celsius; between about 10 degrees Celsius and 100 degrees Celsius; between room temperature and 400 degrees Celsius; between 200 degrees Celsius and 400 degrees Celsius; between 230 degrees Celsius and 350 degrees Celsius. In some implementations, the aforementioned relative humidity values and temperatures are in combination with a pressure between 200 and 2,000 psi; between 500 and 1,500 psi; between 800 and 1,000 psi.

Examples of sulfur-containing streams having the relative water humidity include gaseous phases of water-based streams, such as municipal waste water streams, industrial waste streams, aquifer or ground-water based streams, and combinations thereof.

In one implementation, a multi-component scavenger system for removing sulfur-containing compounds is provided. The multi-component scavenger system comprises at least one scavenger for scavenging sulfur-containing compounds and at least one hygroscopic agent. These components may be added to the gaseous sulfur-containing stream separately in any order or together as a combination or package or blend. It is expected that in most cases, the components will be added as a package for convenience.

The at least one scavenger “scavenges” or otherwise removes or partially removes, sulfur-containing compounds from sulfur-containing hydrocarbon streams, such as crude oil streams or other hydrocarbon streams where the sulfur-containing contaminants may be present from any source. In some implementations, the at least one scavenger comprises any suitable scavenger for removing sulfur-containing compounds. In some implementations, the at least one scavenger is derivable by the reaction of a carbonyl group-containing compound with an alcohol, thiol, amide, thioamide, urea or thiourea. In some implementations, the carbonyl group-containing compound is a carbonyl group-containing compound selected from the group consisting of: formaldehyde, glyoxal, acetaldehyde, propionaldehyde, butyraldehyde, and glutaraldehyde. In some implementations, the at least one scavenger is derivable by reaction of formaldehyde with an amine-free alcohol or urea selected from ethylene glycol, propylene glycol, glycerol, diethylene glycol, triethylene glycol, ethyl alcohol, n-butanol, a sugar, a low molecular weight polyvinyl alcohol, castor oil fatty acid, and urea. The at least one scavenger may be used in combination with amines, for example, monoethanolamine.

In some implementations, the at least one scavenger is a nitrogen containing scavenger. In some implementations, the at least one nitrogen containing scavenger is a triazine. A number of triazines useful in the compositions described herein are commercially available. Available triazines often contain components such as water or unreacted amine. Typically triazines are formed by reacting amines with an aldehyde, especially formaldehyde as is well known in the art. For example, hexahydrotriazines may be made by reacting formaldehyde with an alkanolamine such as monoethanolamine (MEA), and other triazines made using an alkylamine such as monomethylamine, and an alkoxyalkylamine such as 3-methoxypropylamine (MOPA) etc.). MMA-Triazine is a suitable triazine due to its reactivity with sulfhydryl moieties and its commercial availability and relatively low cost. Other suitable triazines include, but are not limited to, MOPA triazine; 1,3,5(tris-methoxyethyl)hexahydrotriazine; 1,3,5(tris-methoxybutyl)hexahydrotriazine; 1,3,5(tris-ethyl)hexahydrotriazine, and 1,3,5(tris-propyl)hexahydrotriazine. The triazines can include compounds where each R group is the same or different. The triazines typically have some water solubility, which solubility may be enhanced by the presence of solvent in the composition. As the ring nitrogen atoms are replaced with sulfur atoms the compounds become less water soluble and may become substantially insoluble in water.

Other suitable nitrogen-containing scavengers which may be used with the implementations described herein, include, but are not necessarily limited to, include monomethylamine (MMA); monoethylamine; dimethylamine; dipropylamine; trimethylamine; triethylamine; tripropylamine; monomethanolamine; dimethanolamine; trimethanolamine; diethanolamine (DEA); triethanolamine (TEA); monoisopropanolamine; dipropanolamine; diisopropanolamine; tripropanolamine; N-methylethanolamine; dimethyl ethanol amine; methyl diethanolamine; dimethyl amino ethanol; diamines; imidazolines; hydroxy amino alkyl ethers; morpholines; pyrrolidones; piperidones; alkylpyridines; aminomethylcyclopentylamine; 1-2-cyclohexanediamine; 1,5-pentanediamine; 1,6-hexanediamine; 1H-azepine, hexahydro; 1,4-butanediamine; alkylene polyamine/formaldehyde reaction products; bis-(tertiarybutylaminoethoxy)-ethane (BTEE); ethoxyethoxyethanoltertiarybutylamine (EEETB); polyvalent metal chelates of aminocarboxylic acids; quaternary ammonium salts; polyethylenimine; polyallylamine; polyvinylamine; aminocarbinols; aminals; bisoxazolidines; reaction products of ethylene diamine with formaldehyde; N-butylamine formaldehyde reaction product, and combinations thereof.

The at least one scavenger may be present in an effective amount for removing desired amounts of the sulfur-containing compound from the gaseous sulfur-containing stream to be treated. The at least one scavenger may be present in the multi-component scavenger system in an amount greater than about 20% by weight; greater than about 30% by weight; greater than about 40% by weight; greater than about 50% by weight; greater than about 60% by weight; greater than about 70% by weight, relative to the total weight of the multi-component scavenger system. The at least one scavenger may be present in the multi-component scavenger system in an amount less than about 80% by weight; less than about 70% by weight; less than about 60% by weight; less than about 50% by weight; less than about 40% by weight; less than about 30% by weight, relative to the total weight of the multi-component scavenger system. The at least one scavenger may be present in the multi-component scavenger system iri an amount between about 20% by weight and about 80% by weight; between about 30% by weight and about 70% by weight; between about 40% by weight and about 60% by weight; between about 45% by weight and about 55% by weight, based on the total weight of the multi-component scavenger system.

In some implementations, the at least one hygroscopic agent is chosen from at least one C₁-C₈ alcohol such as a C₁-C₆ alcohol, at least one C₁-C₈ poly(ol) such as a C₁-C₆ poly(ol)), at least one C₁-C₈ amine such as a C₁-C₆ amine, at least one C₁-C₈ poly(amine) such as a C₁-C₆ poly(amine); at least one C₁-C₄ poly(amine) comprising two —NH₂ functional groups), at least one poly(ether), hygroscopic salts, and mixtures thereof. In some implementations, the at least one hygroscopic agent is chosen from ethanol, sorbitol, ethylene glycol, propylene glycol, 1,3-butylene glycol, dipropylene glycol, diglycerine, meso-erythritol, polyethylene oxide and a mixture thereof, glycerol and derivatives thereof, urea and derivatives thereof, and mixtures thereof. In some implementations, the at least one hygroscopic agent is chosen from glycerine, ethylene glycol, urea, derivatives thereof, and mixtures thereof. In some implementations, where the hygroscopic agent includes a hygroscopic salt the hygroscopic salt may be selected from the group consisting of: calcium chloride, zinc chloride, sodium chloride, magnesium chloride, potassium phosphate, potassium carbonate, potassium hydroxide, and combinations thereof.

The at least one hygroscopic agent may be present in an effective amount for removing desired amounts of the sulfur-containing compound from the gaseous sulfur-containg stream to be treated. The at least one hygroscopic agent may be present in the multi-component scavenger system in an amount greater than about 0.01% by weight; greater than about 0.05% by weight; greater than about 0.1% by weight; greater than about 0.2% by weight; greater than about 0.4% by weight; greater than about 1.0% by weight; greater than about 2.0% by weight greater than about 3.0% by weight; greater than about 4.0% by weight, relative to the total weight of the multi-component scavenger system. The at least one hygroscopic agent may be present in the multi-component scavenger system in an amount less than about 5.0% by weight; less than about 4.0% by weight; less than about 3.0% by weight; less than about 2.0% by weight; less than about 1.0% by weight; less than about 0.4% by weight; less than about 0.2% by weight; less than about 0.1% by weight; less than about 0.05% by weight relative to the total weight of the multi-component scavenger system. The at least one hygroscopic agent may be present in the multi-component scavenger system in an amount between about 0.01% by weight and about 5.0% by weight; between about 0.1% by weight and about 2.0% by weight; between about 0.5% by weight and about 2.0% by weight; between about 0.8% by weight and about 1.5% by weight, based on the total weight of the multi-component scavenger system.

The relative amount of the at least one nitrogen-containing scavenger to the hygroscopic agent will vary over a wide range depending upon the nature of each component. In one implementation, the weight ratio of the at least one scavenger to the at least one hygroscopic agent in the multi-component scavenger may range from about 99.95 to 0.05 to about 95 to 5; from about 99.9 to 0.1 to about 99 to 1; from about 99 to 1 to about 95 to 5; from about 99.9 to 0.1 to about 95 to 5).

In specific applications to remove H₂S from crude oil or other fluid, the multi-componenr scavenger, that is, a combined effective amount of the at least one hygroscopic agent and an effective amount of the at least one nitrogen-containing scavenger, ranging from about 1 to about 100,000 ppm may be introduced into the gaseous sulfur-containing stream to be treated. Typical applications of the multi-component scavenger may involve the addition of between about 1 to about 10,000 ppm (by volume); from about 10 to about 10,000 ppm; from about 50 to about 5,000 ppm; from about 100 to about 200 ppm of multi-component scavenger introduced or injected into the gaseous sulfur-containing stream to be treated. Alternatively, the addition of the multi-component scavenger may be at a rate of up to about 10 times the amount of contaminant present in the dry gas stream, in another non-limiting implementation, at a rate of up to about 5 times the amount of contaminant present. Testing indicates that there is typically sufficient time and temperature for the desired reaction to occur. In any event, sufficient time, conditions, or both, should be permitted so that the multi-component scavenger reacts with substantially all of the contaminant present. By “substantially all” is meant that no significant corrosion, odor, reactant problems, or a combination occur due to the presence of the contaminant(s).

It has also been discovered that the evaporation rate of the fluid in a droplet will slow down with increasing humidity in the droplet's immediate environment to reduce the effect or contribution of the hygroscopic agent, but where humidity levels approach saturation, a suitable hygroscopic agent may absorb some of the surrounding moisture to reduce the initial bulk viscosity of the droplet fluid to increase the diffusion rate of H₂S into the core of the droplet to increase scavenger efficiency compared to a scavenger product that does not contain a hygroscopic component. The hygroscopic agent thus will reduce evaporation rate in low humidity conditions or absorb moisture in very high humidity situations, reducing viscosity of the droplet fluid in both extreme cases to increase diffusion rate of H₂S into the droplet core to increase efficiency of the scavenger, compared to a scavenger product that does not contain a hygroscopic agent.

It will be understood that the complete elimination of corrosion, odor or other problems or complete removal of the sulfur-containing contaminants is not required for successful practice of the method. All that is necessary for the method to be considered successful is for the treated gaseous sulfur-containing stream to have reduced amounts of the sulfur-containing contaminants as compared to an otherwise identical sulfur-containing hydrocarbon stream, sulfur-containing aqueous stream, or both, having no multi-component scavenger, and optionally, a reduced corrosion capability as compared to an otherwise identical sulfur-containing hydrocarbon stream having an absence of multi-component scavenger. Of course, complete removal of a contaminant is acceptable.

The multi-component scavenger system may also contain other additives to facilitate handling, enhance solubility of the scavenger, and avoid operational problems such as foaming and the like. The multi-component scavenger system may further comprise one or more materials selected from the group consisting of water, an organic solvent, surfactants, scale inhibitors, stabilizers, and combinations thereof.

In some implementations the multi-component scavenger system further comprises water. The water may be added as part of the other components of the scavenger system or may be added as a separate component.

Water may be present in an effective amount for removing desired amounts of the sulfur-containing compound from the gaseous sulfur-containing stream to be treated. Water may be present in the multi-component scavenger system in an amount greater than about 15% by weight; greater than about 20% by weight; greater than about 30% by weight; greater than about 40% by weight; greater than about 50% by weight; greater than about 60% by weight; greater than about 70% by weight, relative to the total weight of the multi-component scavenger system. Water may be present in the multi-component scavenger system in an amount less than about 80% by weight; less than about 79.99% by weight, less than about 70% by weight; less than about 60% by weight; less than about 50% by weight; less than about 40% by weight; less than about 30% by weight, relative to the total weight of the multi-component scavenger system. Water may be present in the multi-component scavenger system in an amount between about 15% by weight and about 80% by weight; between about 20% by weight and about 70% by weight; between about 30% by weight and about 60% by weight; between about 30% by weight and about 40% by weight; between about 40% by weight and about 50% by weight, based on the total weight of the multi-component scavenger system.

In some implementations, the multi-component scavenger system further comprises an organic solvent. Suitable organic solvents include solvents that will decrease the freezing point of the multi-component scavenger system, which organic solvents are known as freeze point depressors. Suitable organic solvents for the multi-component scavenger system include, but are not necessarily limited to, formamide, propylene carbonate, tetrahydrofuran, alcohols, glycols, and mixtures thereof alone or without water. Suitable glycols include ethylene glycol and propylene glycol. Suitable alcohols include methanol, ethanol, propanol, ethylene glycol, propylene glycol, and the like can also be used.

The at least one organic solvent may be present in the multi-component scavenger system in an amount greater than about 1% by weight; greater than about 2% by weight; greater than about 5% by weight; greater than about 10% by weight; greater than about 15% by weight, relative to the total weight of the multi-component scavenger system. The at least one organic solvent may be present in the multi-component scavenger system in an amount less than about 20% by weight; less than about 15% by weight; less than about 10% by weight; less than about 5% by weight; less than about 2% by weight, relative to the total weight of the multi-component scavenger system. The at least one organic solvent may be present in the multi-component scavenger system in an amount between about 1% by weight and about 20% by weight; between about 5% by weight and about 15% by weight; between about 5% by weight and about 10% by weight; between about 10% by weight and about 15% by weight, based on the total weight of the multi-component scavenger system.

In some implementations, the multi-component scavenger system further comprises a surfactant. Suitable surfactants include surface active additives that will concentrate at the liquid/air interface to inhibit the water evaporation rate, either by acting as barrier between the water and the air or by inhibiting water evaporation due to inherent affinity to water (“hygroscopic surfactants”). The surfactants may help disperse the multi-component scavenger into the treated dry gas stream. Suitable non-nitrogen-containing surfactants include, but are not necessarily limited to, alkoxylated alkyl alcohols and salts thereof and alkoxylated alkyl phenols and salts thereof, alkyl and aryl sulfonates, sulfates, phosphates, carboxylates, polyoxyalkyl glycols, fatty alcohols, polyoxyethylene glycol sorbitan alkyl esters, sorbitan alkyl esters, polysorbates, glucosides, and the like, and combinations thereof. Other suitable surfactants may include, but are not necessarily limited to, quaternary amine compounds, quaternary ammonium compounds, amine oxide surfactants, silicone based surfactants, and the like. These surfactants can be ionic, such as cationic surfactants such as quaternary alkyl amines or salts such as tetrabutylammomium acetate, tetrabutylammonium bromide, tetrabutylammonium nitrate, etc.; anionic surfactants such as sodium lauryl sulfate or sodium lauryl ether sulfate, or non-ionic surfactants such as polymers or copolymers based on ethylene oxide and propylene oxide and alkoxylates based on substrates such as alkylphenol or alkylphenol based resins, polyamines, other polyols, or mixtures thereof. Exemplary quaternary ammonium based surfactants include alkyl dimethyl benzyl ammonium chloride, dialkyl dimethyl ammonium chloride, didecyl dimethyl ammonium chloride, alkyl dimethyl ethyl benzyl ammonium chloride, and combinations thereof. The surfactant families can also include members from the amphoteric class, such as amine oxides, betaines, etc. Exemplary silicone based surfactants include polyether-functional siloxanes, which could be linear, branched or cyclic in configuration, with oxyalkylate pendant groups based on homopolymers, block-co-polymers or random polymers based on ethylene oxide, propylene oxide, butvlene oxide or higher molecular mass epoxides, such as the TEGOSTAB® family of silicone surfactants.

The at least one surfactant may be present in the multi-component scavenger system in an amount greater than about 0.1% by weight; greater than about 0.2% by weight; greater than about 0.4% by weight; greater than about 0.5% by weight; greater than about 1.0% by weight; greater than about 2.0% by weight greater than about 3.0% by weight; greater than about 4.0% by weight, relative to the total weight of the multi-component scavenger system. The at least one surfactant may be present in the multi-component scavenger system in an amount less than about 5.0% by weight; less than about 4.0% by weight; less than about 3.0% by weight; less than about 2.0% by weight; less than about 1.0% by weight; less than about 0.5% by weight; less than about 0.4% by weight; less than about 0.2% by weight, relative to the total weight of the multi-component scavenger system. The at least one surfactant may be present in the multi-component scavenger system in an amount between about 0.1% by weight and about 5.0% by weight; between about 0.1% by weight and about 2.0% by weight; between about 0.1% by weight and about 0.5% by weight; between about 0.8% by weight and about 1.5% by weight, based on the total weight of the multi-component scavenger system.

In some implementations, the multi-component scavenger system further comprises a scale inhibitor. Scale inhibitors are added to produced waters from oil fields and gas fields to mitigate precipitation of minerals, especially sparingly soluble salts, present in the produced water that would occur during production and downstream processing of the water. Generally the compounds subject to producing scale are referenced as scale formers. Those compounds include but are not limited to: hardness, metals, alkalinity (including but not limited to carbonates), sulfates, silica, and combinations thereof. Such precipitation (scaling) leads to fouling and plugging of piping, valves, process equipment, and the oil-bearing formation. Suitable scale inhibitors are typically formed from organophosphates, polyacrylic acid, polymaleic acid, hydrolyzed water-soluble copolymers of maleic anhydride, polycarboxylates, phosphonates, phosphates, sulfonates and polyamides, along with the use of polyaspartic acids, and their mixtures with surfactants and emulsifiers for inhibiting or delaying precipitation of scale forming compounds. Other suitable scale inhibitors include, but are not necessarily limited to, phosphate esters, acetylenic alcohols, fatty acids, alkyl-substituted carboxylic acids and anhydrides, polyacrylic acids, quaternary amines, sulfur-oxygen phosphates, polyphosphate esters, and combinations thereof

The at least one scale inhibitor may be present in an effective amount for mitigating precipitation of minerals occurring during production. The at least one scale inhibitor may be present in the multi-component scavenger system in an amount greater than about 0.1% by weight; greater than about 1% by weight; greater than about 2% by weight; greater than about 5% by weight; greater than about 10% by weight; greater than about 15% by weight, relative to the total weight of the multi-component scavenger system. The at least one scale inhibitor may be present in the multi-component scavenger system in an amount less than about 20% by weight; less than about 15% by weight; less than about 10% by weight; less than about 5% by weight; less than about 2% by weight; less than about I % by weight, relative to the total weight of the multi-component scavenger system. The at least one scale inhibitor may be present in the multi-component scavenger system in an amount between about 1% by weight and about 20% by weight; between about 5% by weight and about 15% by weight; between about 5% by weight and about 10% by weight; between about 10% by weight and about 15% by weight, based on the total weight of the multi-component scavenger system.

In some implementations, the multi-component scavenger system further comprises at least one stabilizer. A Stabilizer is added to the formulated scanvenger product. Suitable stabilizers include surfactants, polymers, and combinations thereof. Examples of stabilizers include polyethers that could be homopolymers, block-co-polymers or random co-polymers derived from epoxides such as ethylene oxide, propylene oxide, butylene oxide or other epoxides, which may be silicon-free polyethers, as well as siloxane polymers grafted with such polyether pendants and any combinations thereof. The at least one stabilizer may be present in an effective amount for 0.01%. The at least one stabilizer may be present in the multi-component scavenger system in an amount greater than about 0.1% by weight; greater than about 1% by weight; greater than about 2% by weight; greater than about 5% by weight; greater than about 10% by weight; greater than about 15% by weight, relative to the total weight of the multi-component scavenger system. The at least one stabilizer may be present in the multi-component scavenger system in an amount less than about 20% by weight; less than about 15% by weight; less than about 10% by weight; less than about 5% by weight; less than about 2% by weight; less than about 1% by weight, relative to the total weight of the multi-component scavenger system. The at least one stabilizer may be present in the multi-component scavenger system in an amount between about 1% by weight and about 20% by weight; between about 5% by weight and about 15% by weight; between about 5% by weight and about 10% by weight; between about 10% by weight and about 15% by weight, based on the total weight of the multi-component scavenger system.

In one implementation, the multi-component scavenging system comprises from about 20 to about 80 wt. % of the at least one scavenger based on the total weight of the multi-component scavenging system, from about 0.01 to about 5 wt. % of the at least one hygroscopic agent based on the total weight of the multi-component scavenging system, and from about 15 to about 79.9 wt. % water based on the total weight of the multi-component scavenging system.

It will be understood herein that the respective amounts of the aforementioned components and any optional components used in the detectable composition will total 100 weight percent and amounts of the above stated ranges will be adjusted if necessary to achieve the same. In another implementation the methods described herein can use the same composition amounts described above for the composition.

In accordance with the processes of the present disclosure, the multi-component scavenger system is contacted with the gaseous sulfur-containing stream containing the sulfur-containing compounds, especially hydrogen sulfide. The contacting can be effected in any convenient manner such as by injection of the multi-component scavenger composition into a process or transport line; passing the sulfur-containing stream such as a sulfur-containing hydrocarbon stream, for example, a sulfur-containing natural gas stream through a stirred or non-stirred vessel that contains the multi-component scavenger composition; or spraying or otherwise introducing the scavenger composition for contact with the hydrocarbon stream. In some instances, the scavenger composition can be introduced into a well hole. The hydrocarbon stream may contain other components depending upon source. Especially for natural gas streams, nitrogen, carbon dioxide and water are often present. One advantage of the multi-component scavenging system of the present disclosure is that the compositions are sufficiently robust to tolerate presence of other components in the hydrocarbon stream while still scavenging sulfur-containing compounds. The gaseous sulfur-containing streams to be treated in accordance with the present disclosure may contain 5 or more volume percent, such as between about 10 and 1000 ppmV of the sulfur-containing compound.

The duration of the contact between the gaseous sulfur-containing stream and the multi-component scavenger system is sufficient to provide a treated hydrocarbon stream substantially devoid of hydrogen sulfide. A treated hydrocarbon stream substantially devoid of hydrogen sulfide may contain, for example, less than about 1 ppmV of hydrogen sulfide, such as less than about 0.01 ppmV of hydrogen sulfide. In most operations, the multi-component scavenger system is used until an undesired breakthrough of hydrogen sulfide occurs in the treated hydrocarbon stream. The temperature of the contacting can vary over a wide range and will often be determined by the temperature of the environment and the incoming hydrocarbon stream to be treated. In some implementations, the temperature is −10 degrees Celsius or greater; room temperature or greater; between −10 degrees Celsius and 150 degrees Celsius; between about 10 degrees Celsius to 100 degrees Celsius; between room temperature and 400 degrees Celsius; between 200 degrees Celsius and 400 degrees Celsius; between 230 degrees Celsius and 350 degrees Celsius.

When the method scavenges sulfur-containing compounds from a gaseous phase, the method may be practiced by contacting the gaseous phase with droplets of the multi-component scavenger. In one implementation, the multi-component scavenging system is sprayed into the gas stream via atomizing nozzles. Rapid and homogenous distribution of the multi-component oxygen scavenger may be achieved by the multi-component scavenger being sprayed into the gas stream (hydrocarbon stream) via atomizing nozzles. The atomized droplets may have a droplet size, for example, between 5 to 50 micrometers, such as 10 to 20 micrometers.

A suitable atomizing nozzle is any nozzle form known to those skilled in the art. The atomization is performed either due to high velocity of the liquid to be atomized, the high velocity being generated, for example, by a corresponding cross-sectional area constriction of the nozzle, or else via rapidly rotating nozzle components. Such nozzles having rapidly rotating nozzle components are, for example, high-speed rotary bells. A further possibility for atomizing the liquid is passing in addition to the liquid a gas stream through the atomizing nozzle. The liquid is entrained by the gas stream and as a result atomized into fine droplets. For very fine atomization, suitable nozzles are, in particular, atomizing nozzles in which the liquid is atomized by a gas stream, or nozzles having a relatively small bore which require a correspondingly high liquid pressure.

### EXAMPLES

Aspects and advantages of the implementations described herein are further illustrated by the following examples. The particular materials and amounts thereof, as well as other conditions and details, recited in these examples should not be used to limit the implementations described herein. All parts and percentages are by weight unless otherwise indicated.

A description of raw materials used in the examples as follows.
Scale Inhibitor A sodium polyacrylate with an average molecular mass of 2,000 g/mol.
Surfactant An ethylene glycol monobutyl ether (EGMBE) based surfactant.

Test Methods

A Q500 Thermogravimetric Analyzer (TGA), from TA Instruments was used to evaluate the effectiveness of additives to inhibit or delay water evaporation from a scavenger formulation. Typical experimental formulations contained 50 wt. % of MEA-Triazine, with hygroscopic additive concentrations in the range of 0.1 to 2.0 wt. %. The remainder of the formulation is made up with water as solvent. Each formulation was tested by transferring a 25-30 mg sample of the product into the sample holder of the TGA, using a micropipette. The temperature profile was programmed to heat the sample at a ramp rate of 5° C./minute from room temperature and to hold a constant temperature at 80° C. for a period of 4 hours. Then, the samples were rapidly heated (20° C./minute) to 600° C. for a period of 30 minutes as a standard procedure to clean the sample holder. Instrument air was purged through the sample cell at a constant rate of 10 ml/minute. The sample mass was electronically recorded at regular intervals of 1 second to enable calculation the moisture content of the sample as a function of time. Mass loss beyond the 50% level is the result of very slight volatility and some decomposition of the MEA-Triazine itself. The effectiveness of the additive was determined by the difference in mass loss or mass ratio of the product, compared with a control sample without additive. In the following Tables I-III the components are listed in weight percent (Wt. %)

TABLE I
Formulations based on MEA-Triazine and glycerol.

| Component | Formulation ID | | | | | | | | | |
|---|---|---|---|---|---|---|---|---|---|---|
| (wt. %) | A | B | C | D | E | F | G | H | I | J |
| MEA- | 40 | 45 | 50 | 55 | 60 | 50 | 50 | 50 | 50 | 50 |
| Triazine | | | | | | | | | | |
| Water | 59 | 54 | 49 | 44 | 39 | 44.4 | 44.3 | 44.1 | 43.5 | 42.5 |
| Scale | 0 | 0 | 0 | 0 | 0 | 5 | 5 | 5 | 5 | 5 |
| inhibitor | | | | | | | | | | |
| Surfactant | 0 | 0 | 0 | 0 | 0 | 0.5 | 0.5 | 0.5 | 0.5 | 0.5 |
| Glycerol | 1 | 1 | 1 | 1 | 1 | 0.1 | 0.2 | 0.4 | 1.0 | 2.0 |
| (hygroscopic | | | | | | | | | | |
| agent) | | | | | | | | | | |

TABLE II
Formulations based on MEA-Triazine and ethylene glycol.

| Component | Formulation ID | | | | | | | | | | |
|---|---|---|---|---|---|---|---|---|---|---|---|
| (wt. %) | K | L | M | N | O | P | Q | R | S | T | Blank |
| MEA-Triazine | 40 | 45 | 50 | 55 | 60 | 50 | 50 | 50 | 50 | 50 | 50 |
| Water | 59 | 54 | 49 | 44 | 39 | 44.4 | 44.3 | 44.1 | 43.5 | 42.5 | 44.5 |
| Scale inhibitor | 0 | 0 | 0 | 0 | 0 | 5 | 5 | 5 | 5 | 5 | 5 |
| Surfactant | 0 | 0 | 0 | 0 | 0 | 0.5 | 0.5 | 0.5 | 0.5 | 0.5 | 0.5 |
| Glycerol | 1 | 1 | 1 | 1 | 1 | 0.1 | 0.2 | 0.4 | 1.0 | 2.0 | 0 |
| (hygroscopic agent) | | | | | | | | | | | |

TABLE III
Comparative Examples

| | |
|---|---|
| Component | Formulation ID |

| (wt. %) | U | V | W | X | Y | Z |
|---|---|---|---|---|---|---|
| MEA- | 40 | 45 | 50 | 55 | 60 | 50 |
| Triazine | | | | | | |
| Water | 60 | 55 | 50 | 45 | 40 | 44.5 |
| Scale | 0 | 0 | 0 | 0 | 0 | 5 |
| inhibitor | | | | | | |
| Surfactant | 0 | 0 | 0 | 0 | 0 | 0.5 |
| Glycerol | 0 | 0 | 0 | 0 | 0 | 0 |
| (hygroscopic | | | | | | |
| agent) | | | | | | |

FIG. 1 is a graph 100 illustrating the change in weight percent of a known “MEA-Triazine” composition as a function of temperature and time. The MEA-Triazine composition does not contain a hygroscopic agent as disclosed herein. Line 110 represents the temperature of the oven that the MEA-Triazine sample is positioned in. Line 120 represents the weight percent of MEA-Triazine in the sample. As depicted in FIG. 1, as water evaporates from the MEA-Triazine sample, the sample asymptotes around 50% which means that all the water has evaporated and the minor slope is due to decomposition or evaporation of the MEA-Triazine itself.

FIG. 2 is a graph 200 illustrating the effect of mass loss of a droplet due to water evaporation on viscosity of droplet of a known MEA-Triazine composition. The effect of water evaporation on viscosity is depicted in FIG. 2. Mass loss of the droplet (due to water evaporation) as well as the resultant viscosity of the droplet is given as a function of degree of evaporation, represented by the MEA-Triazine concentration of the droplet. The viscosity of the initial droplet with MEA-Triazine concentration at 50% is about 9 centiPoise (“cPs”) at 25° C., but increases to about 360 cPs once 75% of the water content has evaporated (MEA-Triazine concentration of 80% at this point). Further evaporation beyond this level would result in a very steep increase in viscosity.

Not to be bound by theory but it is believed that viscosity increases rapidly with the evaporation of water from a droplet, with decreased H₂S diffusion rates into the droplet core, which could serve as barrier between H₂S in the gas phase and triazine in the viscous droplet, to limit the capacity of scavenger applied. If the rate of water evaporation (from the droplet) is much faster than the rate of reaction with H₂S, in a particular application, it could be that most of the scavenger is trapped in a viscous matrix and not available to react with the H₂S in the gas phase; which could significantly reduce the effectiveness of the scavenger.

FIG. 3 and FIG. 4 are graphs of experimental data obtained from thermogravimetric analysis (TGA) using a Q500 Thermogravimetric Analyzer from TA Instruments according to the procedure previously described herein. A small liquid sample of the experimental scavenger formulation is heated to a constant temperature of 80° C. and the mass of the sample followed as a function of time. The degree of mass loss at any given time is a quantitative indication of the amount of water or the fraction of the water content that has evaporated from the original sample.

FIG. 3 is a graph 300 illustrating the change in weight percent of a triazine scavenger treated with glycerol according to implementations described herein versus an untreated scavenger as a function of temperature and time. Line 310 and 320 both represent untreated Formulation ID C. Line 330 and Line 340 both represent treated Formulation ID H. Line 350 and Line 360 both represent treated Formulation ID I. In FIG. 3, the group of curves marked at “Treated” represent various formulations that contain hygroscopic agents; in this case glycerol at various concentrations between 0.2 And 2.0%. The two curves marked “Untreated” in FIG. 3 represent the control formulations; in this case a blank formulation with the same MEA-Triazine content, but without any glycerol or other hygroscopic agent content. The results depicted in FIG. 3 demonstrate the noticeable difference in mass loss profiles between formulations with glycerol as the hygroscopic agent compared to the control. The reduction in water loss for the “Treated” samples as result of the hygroscopic agent results in a much lower droplet viscosity, especially during the earlier stages prior to equilibration. A lower viscosity droplet will allow higher H₂S diffusion rates into the liquid scavenger drop and thus a faster, more complete scavenger reaction. At high water loss, the scavenger droplet viscosity might increase enough to prevent complete stoichiometric reaction and reduce scavenger efficiency as result.

FIG. 4 is a graph 400 illustrating the change in weight percent of a triazine scavenger treated with ethylene glycol according to implementations described herein versus an untreated scavenger as a function of time. Line 410 represents untreated Formulation ID Blank. Line 420 represents treated Formulation ID Q. Line 430 represents treated Formulation ID S. Line 440 represents treated Formulation ID T. FIG. 4 shows similar results obtained by using ethylene glycol as the hygroscopic agent. The control curve for a scavenger sample that did not contain ethylene glycol or any other hygroscopic agent in the formulation shows a fast mass loss due to water evaporation from the sample. All formulations that contained ethylene glycol as the hygroscopic agent at concentrations between 0.25% and 2% shows very similar results, but much different from the control sample. Formulations with ethylene glycol showed significant delay in water evaporation to delay viscosity increase during the lifetime of the scavenger drop in the application. It is believed that lower viscosity of the scavenger droplets allows for higher H₂S diffusion rates into the core of the droplet, which allows for increased scavenger capacity.

Although the implementations described herein are typically used for scavenging sulfur-containing compounds from gaseous sulfur-containing streams, it should understood that some implementations described herein are also applicable to applications where droplets of water or water based additive are atomized/misted into a system.

While the foregoing is directed to implementations of the present disclosure, other and further implementations of the disclosure may be devised without departing from the basic scope thereof, and the scope thereof is determined by the claims that follow.

What is claimed is:

1. A method for scavenging a sulfur-containing compound from a gaseous sulfur-containing stream comprising:
contacting the gaseous sulfur-containing stream with a multi-component scavenging system for scavenging the sulfur-containing compound, wherein the multi-component scavenging system comprises:
at least one scavenger for scavenging the sulfur-containing compound; and
at least one hygroscopic agent; and
wherein the gaseous sulfur-containing stream has an amount of water less than or equal to 100% relative humidity and the gaseous sulfur-containing stream comprises the sulfur-containing compound.

2. The method of claim 1, wherein the at least one hygroscopic agent is selected from the groups consisting of: at least one alcohol of C₁-C₈, at least one polyol) of C₁-C₈, at least one amine of C₁-C₈, at least one poly(amine) of C₁-C₈, at least one C₁-C₄ poly(amine) comprising two —N₂ functional groups, at least one poly(ether), at least one aldehyde of C₁-C₈, at least one hygroscopic salt, and mixtures thereof.

3. The method of claim 2, wherein the at least one hygroscopic agent is selected from the group consisting of: ethanol, sorbitol, ethylene glycol, propylene glycol, 1,3-butylene glycol, dipropylene glycol, diglycerine, meso-erythritol, polyethylene oxide and a mixture thereof, glycerol and derivatives thereof, urea and derivatives thereof, and mixtures thereof.

4. The method of any of claim 2, wherein the at least one hygroscopic agent is selected from the group consisting of formaldehyde, glycerine, ethylene glycol, meso-erythritol, urea, derivatives thereof, and mixtures thereof, and wherein the at least one hygroscopic agent is the at least one hygroscopic salt selected from the group consisting of: calcium chloride, zinc chloride, sodium chloride, magnesium chloride, potassium phosphate, potassium carbonate, potassium hydroxide and combinations thereof.

5. The method of claim 1, wherein, the at least one scavenger for scavenging the sulfur-containing compound is a triazine selected from the group consisting of: monoethanolamine (MEA)-triazine, monomethylamine (MMA)-triazine, 1,3,5(tris-methoxybutyl)hexahydrotriazine, 1,3,5(tris-ethyl)hexahydrotriazine, 1,3,5(tris-propyl)hexahydrotriazine, monomethylamine (MMA), monoethylamine, dimethylamine, dipropylamine, trimethylamine, triethylamine, tripropylamine, monomethanolamine, dimethanolamine, trimethanolamine, diethanolamine (DEA), triethanolamine (TEA), monoisopropanolamine, dipropanolamine, diisopropanolamine, tripropanolamine, N-methylethanolamine, dimethyl ethanol amine, methyl diethanolamine, dimethyl amino ethanol, diamines, imines, imidazolines, hydroxy amino alkyl ethers, morpholines, pyrrolidones, piperidones, alkylpyridines, aminomethylcyclopentylamine, 1-2cyclohexanediamine, 1,5-pentanediamine, 1,6-hexanediamine, 1 H-azepine, hexahydro, 1,4-butanediamine, alkylene polyamine/formaldehyde reaction products, bis-(tertiarybutylaminoethoxy)-ethane (BTEE), ethoxyethoxyethanoltertiarybutylamine (EEETB), polyvalent metal chelates of aminocarboxylic acids, quaternary ammonium salts, polyethylenimine, polyallylamine, polyvinylamine, aminocarbinols, aminals, bisoxazolidines, reaction products of ethylene diamine with formaldehyde, and combinations thereof.

6. The method of claim 1, wherein the ratio of the at least one scavenger for scavenging the sulfur-containing compound to that at least one hygroscopic agent in the multi-component scavenger ranges from 99.9 to 0.1 to about 95 to 5, or wherein the at least one scavenger for scavenging the sulfur-containing compound is in an at least 20 wt. % aqueous solution, or wherein the multi-component scavenger further comprises a scale inhibitor selected from the group consisting of: phosphate esters, acetylenic alcohols, fatty acids, alkyl-substituted carboxylic acids and anhydrides, quaternary amines, sulfur-oxygen phosphates, polyphosphate esters, and combinations thereof, or a combination thereof.

7. The method of claim 1, wherein the multi-component scavenger system further comprises a surfactant selected from the group consisting of: quaternary alkyl amines, tetrabutylammomium acetate, tetrabutylammonium bromide, tetrabutylammonium nitrate, sodium lauryl sulfate, sodium lauryl ether sulfate, as polymers or copolymers based on ethylene oxide and propylene oxide and alkoxylates based on substrates such as alkylphenol or alkylphenol based resins, polyamines, and combinations thereof, or wherein the multi-component scavenging system is present in the gaseous sulfur-containing stream in an amount ranging from about 1 to about 100,000 ppm, or a combination thereof.

8. The method of claim 1, wherein the at least one hygroscopic agent is present in the multi-component scavenger system in an amount between about 0.01% by weight and about 5.0% by weight based on the total weight of the multi-component scavenger, wherein the gaseous sulfur-containing stream has an amount of water less than or equal to 60% relative humidity, or a combination thereof.

9. The method of claim 1, wherein contacting the gaseous sulfur-containing stream with the multi-component scavenging system comprises spraying droplets of the multi-component scavenging system into the gaseous sulfur-containing stream via atomizing nozzles.

10. The method of claim 9, wherein the droplets of the multi-component scavenging system have a diameter from about 5 micrometers to about 50 micrometers.

11. A multi-component scavenging system for scavenging a sulfur-containing compound, comprising:
at least one scavenger for scavenging the sulfur-containing compound; and
at least on hygroscopic agent selected from the group consisting of: at least one alcohol of C₁-C₈, at least one poly(ol) of C₁-C₈, at least one amine of C₁-C₈, at least one poly(amine) of C₁-C₈, at least one C₁-C₄ poly(amine) comprising two —NH₂ functional groups, at least one poly(ether), at least one aldehyde of C₁-C₈, at least one hygroscopic salt, and mixtures thereof.

12. The multi-component scavenging system of claim 11, wherein the at least one hygroscopic agent is present in an amount from about 0.01 to about 5 wt. % of the total weight of the multi-component scavenging system.

13. The multi-component scavenging system of claim 11, wherein the at least one scavenger for scavenging the sulfur-containing compound is a nitrogen containing scavenger selected from the group consisting of: mononethanolamine (MEA)-triazine, monomethylamine (MMA)-triazine, and combinations thereof.

14. The multi-component scavenging system of claim 11, wherein the at least one hygroscopic agent is selected from the group consisting of: ethanol, sorbitol, ethylene glycol, propylene glycol, 1,3-butylene glycol, dipropylene glycol, diglycerine, meso-erythritol, polyethylene oxide and a mixture thereof, glycerol and derivatives thereof, urea and derivatives thereof, formaldehyde, glycerine, ethylene glycol, meso-erythritol, urea, derivatives thereof, and mixtures thereof.

15. The multi-component scavenging system of claim 11, wherein, the at least one nitrogen containing scavenger is a triazine selected from the group consisting of:
monoethanolamine (MEA)-triazine, monomethylamine (MMA)-triazine, 1,3,5(tris-methoxybutyl)hexahydrotriazine; 1,3,5(tris-ethyl)hexahydrotriazine, and 1,3,5(tris-propyl)hexahydrotriazine and combinations thereof.

16. The multi-component scavenging system of claim 11, wherein the multi-component scavenger further comprises: a scale inhibitor selected from the group consisting of: phosphate esters, acetylenic alcohols, fatty acids, alkyl-substituted carboxylic acids and anhydrides, quaternary amines, sulfur-oxygen phosphates, polyphosphate esters, and combinations thereof.

17. The multi-component scavenging system of claim 11, wherein the multi-component scavenger system further comprises a surfactant selected from the group consisting of: quaternary alkyl amines, tetrabutylammomium acetate, tetrabutylammonium bromide, tetrabutylammonium nitrate, sodium lauryl sulfate, sodium lauryl ether sulfate, as polymers or copolymers based on ethylene oxide and propylene oxide and alkoxylates based on substrates such as alkylphenol or alkylphenol based resins, polyamines, and combinations thereof.

18. The multi-component scavenging system of claim 11, wherein the at least one nitrogen containing scavenger is present in an amount from about 20 to about 80 wt. % of the total weight of the multi-component scavenging system.

19. The multi-component scavenging system of claim 11, comprising:
from about 20 to about 80 wt. % of the at least one nitrogen containing scavenger based on the total weight of the multi-component scavenging system;
from about 0.01 to about 5 wt. % of the at least one hygroscopic agent based on the total weight of the multi-component scavenging system; and
from about 15 to about 79.99 wt. % water based on the total weight of the multi-component scavenging system.

20. A treated stream comprising:
a gaseous sulfur-containing stream;
a sulfur-containing contaminant; and
the multi-component scavenger of claim 11 in an amount effective to at least partially remove the sulfur-containing contaminant from the gaseous sulfur-containing stream.
